(19) United States
(12) Patent Application Publication
(10) Pub. No.: US 2011/0240391 A1
(43) Pub. Date: Oct. 6, 2011

(54) Electric Two-Wheeler

(75) Inventor: Jacques Bonneville, Lagny Sur Marne (FR)

(73) Assignee: MATRA MANUFACTURING & SERVICES, Paris (FR)

(21) Appl. No.: 13/072,501

(22) Filed: Mar. 25, 2011

(30) Foreign Application Priority Data
Apr. 1, 2010 (FR) FR1052487

(51) Int. Cl. B60L 11/18

(52) U.S. Cl. 180/220

(57) ABSTRACT

Electric two-wheeler comprising a first frame element extending from an upper end carrying a steering tube for a front wheel to a lower end, a second frame element extending from an upper end receiving a seat to a lower end rigidly fixed to the first frame element, a battery casing arranged in a battery housing space in rolling configuration, and an electric drive motor. The battery housing space is delimited at least in the vertical plane by a lower portion of the first frame element, a lower portion of the second frame element, and a footboard unit. The lower portions have bottom ends connected together and top ends between which the footboard unit extends in rolling configuration.

The present invention relates to an electric two-wheeler, in particular a two-wheeler of the electric power assisted bike or bicycle type which is becoming increasingly successful in urban use.

More particularly, this is a two-wheeler comprising:
a first frame element extending from an upper end carrying a steering tube of a front wheel to a lower end,
a second frame element extending from an upper end receiving a seat unit to a lower end rigidly fixed to the first frame element,
a battery casing arranged in a battery housing space in rolling configuration, and
an electric motor driving one of the wheels.

A specialist in bike frames will of course understand that the first frame element corresponds to the down tube, the second frame element corresponds to the seat tube, and the support members for the rear wheel correspond to the chain stays in the usual terminology. However, to avoid an excessively limited interpretation of the protection, these terms have not been used. In fact, they can be hollow tubes with a constant section, but also elements that are solid or have a variable section, or also several parts assembled together by welding or any other technique.

The long evolution that bike frames have undergone has resulted in relatively standard forms according to their use, which offer a satisfactory compromise between several criteria. Among these criteria, mention can be made in particular of the stiffness of the frame, its light weight, its practical character for the use in question and its geometric characteristics, which have a significant effect on the dynamic behaviour of the bike.

The recent appearance of two-wheelers with electric motors, whether simply to assist pedalling or as a principal means of propulsion, of course requires a battery to be carried, which is a particularly heavy element and has a degree of sensitivity to shocks. The integration of a battery in a frame having one of the configurations usual for bikes poses problems.

Among the solutions currently retained, it is known to place an elongated-shape battery behind the seat tube. This solution is not entirely satisfactory in particular because it displaces the centre of gravity and requires a substantial modification of the seat stays, hence there is a risk of structural weakness of the frame at this level. It is also not entirely satisfactory for producing an easily detachable battery system.

Another solution is to house a battery in an enlarged hub of one, or even both, of the wheels. The behaviour of the bike is then not significantly changed and its structure is almost identical to that of a normal bike, which guarantees a satisfactory strength and behaviour. However, this solution requires a design of the batteries and their connections that makes them substantially more expensive. Moreover, in this case, it is almost impossible to produce a detachable assembly allowing the user to remove and replace it easily. Urban users very often do not have power supply means allowing the bike to be recharged in its parking space. They are therefore forced to remove and re-place the battery to recharge it at home.

The present invention therefore aims to improve the integration of a battery in an electric two-wheeler, having the aim of improving the existing systems in relation to one or other of the problems mentioned above.

To this end, a subject of the present invention is a two-wheeler of the above-named type, wherein the battery housing space is delimited, at least in the vertical plane, by a lower portion of the first frame element, a lower portion of the second frame element, and a footboard unit, said lower portions having bottom ends connected together and top ends between which the footboard unit extends in rolling configuration, and wherein the footboard unit has, at one end, a hinge pivotably connecting said unit to one of the lower portions.

The battery is thus arranged in the bottom part of the frame, a part which can be even lower than for usual bike frames by adopting some of the preferred arrangements below. The actual battery and its casing are thus protected by the frame, which passes underneath, while the footboard protects the upper side. The battery casing remains accessible because it is not surrounded on each side by frame elements. It is possible in particular to take it out laterally from the side opposite to the chainring by correctly positioning the pedal. However, lateral protections can be provided, and the accessibility can still be improved by way of some of the arrangements below.

In preferred embodiments, it is also possible to make use of one or other of the following arrangements.

The lower portion of the first frame element has a concave-curved shape oriented substantially towards the seat unit. The lower portion of the second frame element can also have a curved shape with a concavity oriented substantially forwards. This is in order to increase the available space in the bottom of the frame.

The footboard unit extends substantially horizontally with an upper surface situated at a height comprised between the height of the axis of the wheels and 45 cm. It was determined that, with a footboard comprised within this height range, use in town remained just as practical as with a customary open frame, and the footboard even provided an element of comfort when stationary.

The lower portion of the second frame element comprises a crankset housing, said housing being situated at a distance from the bottom end of said lower portion. This unusual arrangement of the crankset housing allows the lower portion of the first frame element to be lowered, and the battery housing space to thus be increased.

The footboard unit has, at an opposite end to the hinge, a locking device connecting said unit to the other lower portion in unlockable manner. By way of this arrangement, it is possible to reach the battery from the top, or even to be able to lift the battery out in a removal configuration.

The footboard unit has an external electrical connection member, said connection member being arranged close to the hinge of the footboard unit. This arrangement has the advantage of allowing a simple electrical connection with a short cable.

The battery casing is attached in a detachable manner to the hinged footboard unit. It is thus possible to move the footboard away from the frame, then detach the battery casing in a more practical position.

The hinge of the footboard unit, preferably connected to the second frame element, allows pivoting about a transversal horizontal axis allowing said footboard unit to pass from the rolling configuration to a substantially vertical configuration, called “removal configuration”. By way of this arrangement, the user does not have to bend down much to remove the battery casing.

The locking device is suitable for locking the footboard unit in the removal configuration. The removal configuration is thus stable, which facilitates the operation of removing and replacing the battery casing, an operation which can even be carried out with one hand.

The locking device comprises a mobile member mounted on the footboard unit and a first strike member mounted in fixed manner on one of the frame elements, and a second strike member mounted in fixed manner on the other frame element, said mobile member being biased toward the locked position and the first and second strike members being configured to automatically ensure the locking when the footboard unit reaches one of the rolling and removal configurations. The system is thus even more practical and reliable.

The battery casing and the footboard unit are attached in detachable manner by a set of tracks allowing disengagement according to a translation movement over a disengagement course substantially parallel to the footboard unit and in an opposite direction to the hinge thereof. A simple pull then allows the battery to be disengaged.

Other characteristics and advantages will become apparent from the following description, given by way of non-limitative example of a preferred embodiment, with reference to the figures, in which:

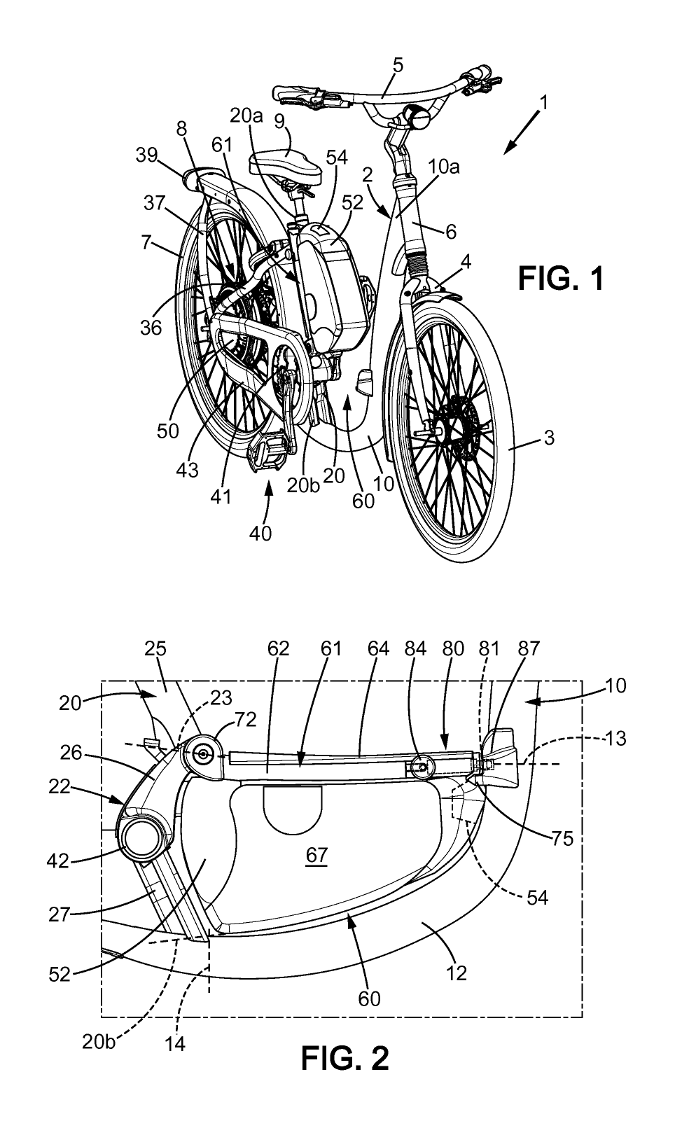

FIG. 1 is a perspective view of a bike having a housing space for a battery casing according to the invention and in removal configuration.

FIG. 2 is an enlarged side view of the battery housing space in rolling configuration.

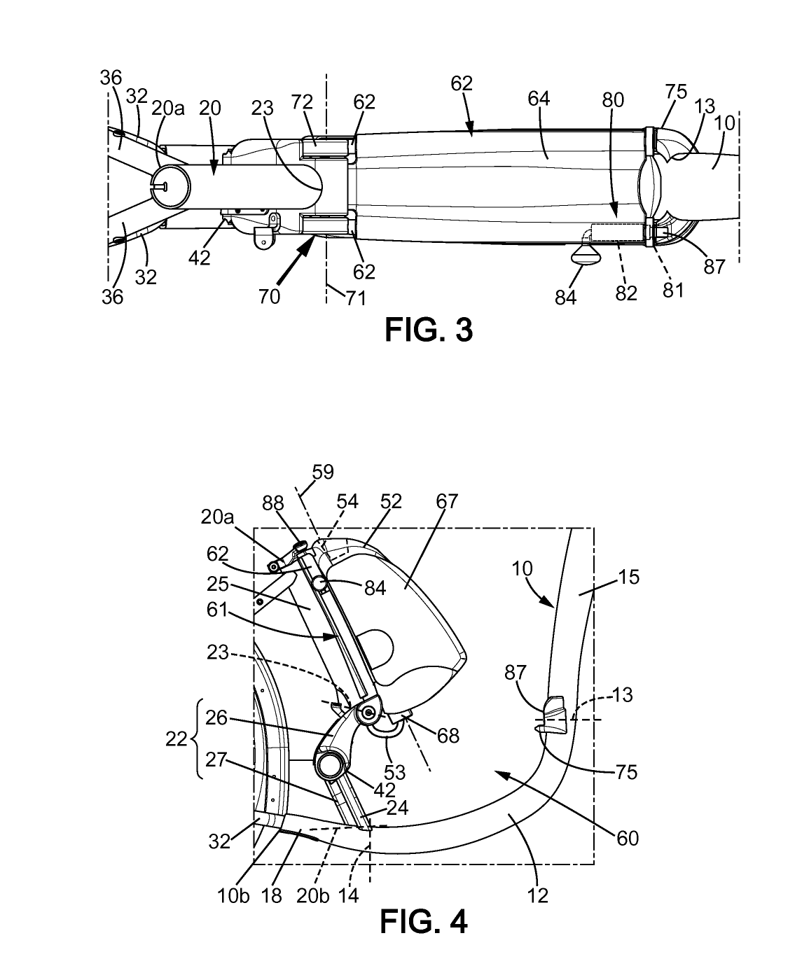

FIG. 3 is a top view of FIG. 2;

FIG. 4 is a view analogous to FIG. 2 with the battery casing in removal configuration, and

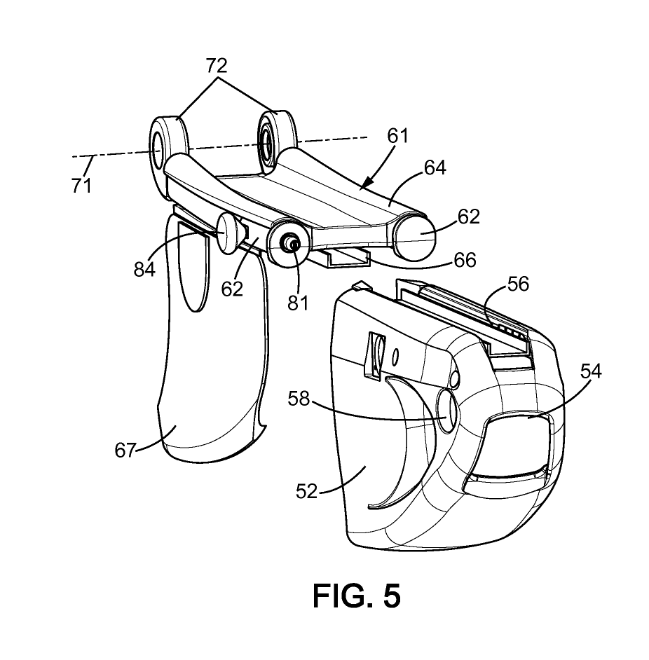

FIG. 5 is a perspective view of a footboard unit delimiting part of the battery housing space and a battery casing disengaged from this unit.

The same references denote identical or similar components in the different figures.

A two-wheeler 1 of the city bike type with an open frame 2 is shown in FIG. 1.

The bike 1 comprises, in known manner, a front wheel 3 borne by a fork 4 rigidly fixed to a handlebar unit 5. The fork 4 is pivotably mounted through a steering tube 6, or steering box, rigidly fixed to the frame 2. The bike 1 also comprises a rear wheel 7 borne by a rear fork 8 rigidly fixed to the frame 2, as well as a seat unit 9.

The bike 1 is an electric power assisted bike. However, it will be understood from the following description that it could be a somewhat different type of two-wheeler, for example a scooter or a light electric motorcycle type, provided certain characteristics of the frame 2 are retained.

The frame 2 comprises a first frame element 10 extending from an upper end 10a rigidly fixed to the steering tube 6 to a lower end 10b that can be seen in FIG. 4. The first frame element 10 substantially corresponds to the part called “down tube” in the field of bikes. It is in fact formed from a tube, but to which modifications have been made such that it has variations in cross-section and more or less curved portions. Additional elements are also attached by welding. This first frame element 10 could, however, be produced from several assembled elements or also comprise solid elements.

On the first frame element 10, a lower portion 12 extending between a top end 13 and a bottom end 14 indicated in FIGS. 2 and 4 by broken lines and the position of which will be defined below are considered. The first frame element 10 therefore comprises a top portion 15 between the top end 13 and the upper end 10a. In the embodiment shown, a further portion 18 extends between the bottom end 14 and the lower end 10b. The bottom 14 and lower 10b ends could, however, be merged and the further portion 18 absent.

The frame 2 comprises a second frame element 20 extending from an upper end 20a on which is mounted the seat unit 9, comprising a seat tube, adjustment means and the actual seat, to a lower end 20b rigidly fixed to the first frame element 10. Analogously, a lower portion 22 extending from a top end 23 to a bottom end merged with the lower end 20b can be defined for the second frame element 20. The second frame element 20 therefore has an upper portion 25 here formed by a straight tube. On the other hand, the lower portion 22 is formed of two relatively complex parts (26, 27) which form an irremovable stiff assembly with the remainder of the frame 2.

The rear fork 8 usually comprises a pair of base elements 32 extending on either side of the rear wheel 7 from the lower end 10b of the first frame element to a rear wheel spindle support. The rear fork 8 also comprises a pair of seat stays 36 extending from the spindle support to the second frame element 20, and more particularly close to the upper end 20a thereof. The rear fork 8 thus forms a stiff and light unit capable of keeping the rear wheel 7 in a vertical plane aligned with the vertical plane of the frame 2.

The rear part of the bike also comprises a mudguard 39 supported by a pair of additional stays 37 which are here rigidly fixed to the frame, but which could of course be attached elements.

In the case of a bike, the latter comprises a transmission assembly 40 comprising a crankset 41 borne by a housing 42 that can be seen in FIG. 2, a transmission member, such as a chain or a belt, masked in the figures by a cover 43, and one or more rear sprocket wheels.

The bike also comprises an electric propulsion system. In the embodiment shown, it is a power assist system, i.e. one that functions automatically, in particular as a function of the pedalling effort exerted. However, it could be a system the electric propulsion force of which is controlled directly by the user.

The propulsion system comprises an electric motor 50 housed in the hub of the rear wheel 7, an electric battery housed in a battery casing 52 and a connection by cable 53 between the battery and the motor. A control and display module, not shown, is also provided on the handlebar unit 5 and is connected to the electric motor 50 and the battery casing 52. It allows the electric assist to be operated according to different modes and operating parameters or the charge state of the battery to be displayed.

The battery casing 52 can comprise, besides the actual battery elements, electronic circuits able to perform different functions such as in particular determining the state of charge of the battery, but also providing a control signal to the motor 50 from signals received from sensors such as a speed sensor and a pedal torque sensor. The casing 52 is present in the form of a stiff outer body shell which comprises an electrical connector for transmitting electric power on the one hand and signals on the other.

The casing 52 also has a grip member 54 which can be produced in the form of a recess as indicated by a discontinuous line. The grip member could of course be produced differently, such as for example a protruding part or a mobile part protruding from the casing in a battery removal configuration and able to be folded down to the surface of the casing for a rolling configuration.

The battery casing 52 also comprises attachment means advantageously formed by a track 56. The battery casing 52 can also have a key lock 58 for actuating an anti-theft system for the battery. The battery casing 52 can be a standard element. However, it has a main axis of elongation 59 and the attachment track 56 is preferably oriented in a direction substantially parallel to the axis of elongation 59.

In order to optimize the fitting of the battery in the bike, a battery housing space 60 is defined in the frame 2 by the lower portion 12 of the first frame element 10, the lower portion 22 of the second frame element 20 and a footboard unit 61 which extends between a zone of the first frame element 10 and a zone of the second frame element 20 which define the top ends 13 and 23 of the lower portions 12 and 22. As the bottom ends 14 and 20b of the lower portions (12, 22) are adjacent, the battery housing space 60 is thus surrounded by a continuous loop in the plane of the frame 2, i.e. in the vertical plane.

The lower portions (12, 22) forming part of the frame 2 are necessarily robust members which can withstand significant shocks. Thus, the battery casing 52 is protected against shocks from elements protruding from the ground, such as a bike parking stand or a pavement.

The footboard unit 61 is preferably also a robust unit here formed of lateral metallic tubes 62 and covered on the upper face by a plate 64 forming the actual footboard. As the footboard unit 61 is solid, it protects the battery casing 52, but advantageously provides a support member for attaching the battery. This member is here produced by a track 66 complementary to the track 56 of the casing and connected to the lateral tubes 62, as can be seen in FIG. 5.

The battery housing space 60 can also be delimited laterally by fixed or mobile protection elements. For example, a lateral cover plate 67 in the form of a plastic plate which partially covers the side of the battery casing 52 is shown in the figures. It is in fact preferred to replace the lateral cover plate 67 with a flexible bag permanently suspended on the footboard unit 61 and provided with a zip fastener for closing the battery casing 52 therein. Such a flexible bag, for example produced from synthetic fabric, allows the battery casing 52 to be kept perfectly clean, even when it is raining, and it is however perfectly conceivable not to provide any lateral protection, in particular if a lateral removal of the battery from the opposite side of the crankset 41 is envisaged. In fact, experience shows that the risks of lateral shocks able to damage the battery casing remain limited. It should be noted that the battery housing space 60 is situated in a zone of the frame 2 which is not surrounded laterally by structural elements, such as the rear fork 8, the left pedal being able to be easily positioned adequately. An easy lateral access to the battery casing 52 is therefore perfectly possible, in particular if a footboard unit 61 permanently fixed, for example by welding, is produced, for reasons of cost.

The footboard unit 61 also supports an electrical connector 68 to which the feed cable 53 of the motor 50 is connected. The pins of this connector are oriented along the axis of the track 66 and arranged relative to the complementary connector of the battery casing 52 such that the engagement of the set of tracks (56, 66) in translation guides the engagement of the connector 68 connected to the frame 2 with the complementary connector of the battery casing.

It will be noted that the lower portion 12 of the first frame element 10 is not straight, as is usual for a down tube, but has a curved shape with a cavity oriented upwards and backwards, approximately in the direction of the seat unit 9. In fact, the average radius of curvature between the top and bottom ends of this portion, indicated in FIG. 4 by the broken lines 13 and 14, has a centre of rotation approximately situated at the upper end 20a of the second frame element. More specifically, the lower portion 12 has a relatively pronounced curvature in its top part and a straighter bottom portion. Thus, the lower portion 12 is situated further forward overall relative to the corresponding portion of a usual down tube.

The lower portion 22 of the second frame element 20 also has a curvature between its top and bottom ends (23, 24), such that this portion has a concavity oriented forwards. These curvatures increase the battery housing space 60. This lower portion 22 formed of the two short parts (26, 27) welded to the cylindrical crankset housing 42 allows a perfectly satisfactory solidity to be obtained, even more so as the second frame element 20 is subjected to limited bending stresses because of the presence of the seat stays 36.

On the other hand, for the first frame element 10, it is preferable to produce it in a single piece and without a pronounced angle, especially if it is an open frame 2, as in the embodiment shown.

Placing the crankset housing 42 on the lower portion 22 of the second frame element 20, and not at the junction with the first frame element 10 makes it possible to lower the lower portion 12 of the first frame element 10 and to further increase the space 60 for housing the battery casing. In fact, the position of the crankset housing 42 can be modified vertically only by a few tens of millimetres around a height of around 27 cm, which is considered to be an optimum between the pedalling comfort and the risk of the pedals touching the ground when turning. Here, the axis of the crankset 41 is situated substantially in the median part of the lower portion 22 of the second frame element 20. A higher position compared with the lower end 20b of this element is possible. However, other constraints are to be taken into consideration. It is preferable in particular that the first frame element 10 does not have a zone situated at a height lower than 12 cm, to avoid contact with the usual obstacles encountered in town.

On the other hand, the fact that the footboard unit 61, and more specifically its upper face 64, is situated higher than the axis of the crankset 41 also allows the battery housing space 60 to be increased. In particular, it is found that a height of around 35 cm offers a very good ease of use, in particular for passing a foot through the frame 2. It is possible to fit the upper face 64 of the footboard unit higher, but preferably without exceeding a height of 45 cm, beyond which this comfort decreases.

As can be seen more clearly in FIG. 3, the upper face 64 is wider horizontally than the frame elements 10 and 20. This width, which increases slightly towards the front, in fact corresponds to the width of a shoe and this upper face is configured to receive the foot of a user. Although the use of a footboard with a bike seems a priori of little interest, it is assumed and confirmed by early tests that the footboard unit 61 allows a foot to rest comfortably on top and can be greatly appreciated by users. In fact, during urban use, the user has to stop many times and this foot-rest function of the footboard unit 61 should substantially improve comfort. The upper face 64 must not be substantially wider, at the risk of interfering with pedalling. Of course, it will be understood that this foot-rest function does not necessarily have to be performed by the member 61 called “footboard unit” in order to improve the fitting of a battery in an electric bike.

According to a particularly advantageous additional characteristic, the footboard unit 61 is mobile relative to the frame 2 by way of a hinge hinge 70. The hinge 70 allows the footboard unit 61 and the battery casing 52 mounted detachably on it, in the embodiment shown, to be made to pass from a rolling configuration shown in FIG. 2 to a removal configuration shown in FIGS. 1 and 4. This removal configuration is designed to make the removal of the battery casing 52 from the frame 2 even easier. Different hinges are possible for performing this function.

In the preferred embodiment, the hinge 70 is a pin connection having a horizontal axis 71 perpendicular to the longitudinal direction of the frame 2. It is situated at the connection between the footboard unit 61 and the second frame element 20. The hinge 70 is formed by lugs 72 integral with the rear end of the lateral tubes 62 and mounted pivoting on slugs situated at the top end 24 at the lower portion 22. In the configuration of use shown in FIG. 2, the front end of the lateral tubes 62 comes to rest on stops 75 welded on the first frame element 10 at the level of the top end 13.

A locking device 80 allows the footboard unit 61 to be immobilized in this rolling configuration. The locking device 80 comprises a sliding bolt 81 mobile in translation in the right lateral tube 62 and stressed in the protruding position, that can be better seen in FIG. 5, by a spring 82 indicated by broken lines in FIG. 3. A handle 84 allows the sliding bolt 81 to be retracted by compressing the spring 82. Thus, the sliding bolt 81 which forms the mobile member of the bolt can be disengaged from a recess forming a first strike member 87 situated slightly above the right lateral stop 75.

It will be noted that the strike member 87 has a smooth and rounded outer face against which the end of the sliding bolt 81 can slide while being pushed back by its retracted position.

A reversed arrangement of the hinge 70 and the locking device 80 is of course possible. However, it has proved that the position of the hinge 70 on the second frame element 20 is more ergonomic, the user more naturally tending to position himself at one side of the seat unit 9.

As can be seen in FIG. 4, a second strike member 88 is provided close to the upper end 20a of the second frame element. The second strike member 88 is arranged in order that the sliding bolt 81 cooperates with it when the footboard unit 61 is placed in the removal configuration. The second strike member 88 has a rounded surface around the recess receiving the sliding bolt, such that the latter can be pushed back by this surface before engaging automatically with the recess of this member under the action of the spring 82.

The fitting of the battery in the housing space 60 does not significantly change the behaviour of the bike due to its low position. The structure and in particular the strength of the rear fork 8 are not affected. The removal and replacement of the battery casing 52 is easy since it is situated in a relatively accessible area.

In particular, in the embodiment shown, the operations of removing the battery casing 52 are particularly easy and intuitive. From the rolling configuration shown in FIG. 2, the user exerts a rearward pull on the handle 84, which releases the locking device 80. This action is followed naturally by an upward movement, the user generally being situated beside the seat, and the footboard unit 61 with the battery casing 52 pivots upwards. The sliding bolt 81 is guided towards the second locking member 88 and automatically cooperates with the rounded outer surface thereof such that the locking device 80 automatically engages with this second strike member 88. The removal configuration thus achieved, shown in FIG. 4, is then stable.

It will be noted that the battery casing 52 is in a substantially higher position and that the grip member, or handle 54 arranged opposite the hinge 70, faces the user. However, if the battery casing 52 cannot be seen because enclosed in a flexible bag, it is then wise to place the system for opening this bag, such as for example the slider of a zip fastener, opposite the handle 54.

The user then exerts an upward pull on the handle 54, which allows the tracks 56 and 66 of the detachable mounting system to be disengaged while disengaging the connector 68 from the complementary connector of the casing 52. The translation movement for disengaging the tracks can be made over a short distance, and not necessarily over the whole of their length, by providing fastening hooks and notches on the tracks (56, 66).

The replacement of the battery and the return to the rolling configuration are carried out substantially following the reverse procedure. Once the battery casing 52 is re-engaged with the mounting means 66 of the footboard unit 61, this unit is unlocked from the removal position by a downward action on the handle 84. This unit 61 and the battery casing 52 pivot downwards to come into contact with the stops 75. During this pivoting movement, the lock device 80 automatically locks with the first strike member 87 because of the smooth and curved outer surface thereof.

It will be noted that the connector 68 connected to the footboard unit 61 is situated close to the hinge 70, such that it is not necessary to provide a very great free length of cable 53.

The embodiment described above is in no way limitative. It will be understood that the delimitation of the housing space 60 in the vertical plane can differ substantially according to the shape given to the lower portions (12, 22) of the frame elements (10, 20), and of the shape of the footboard unit 61, which is not necessarily straight. However, it is preferable that this shape corresponds substantially to the external shape of the battery casing 52. As it has already been mentioned, the hinged mounting of the footboard unit 61 is only one option, the battery casing 52 being able to be easily removed in a lateral movement.

1. Electric two-wheeler comprising:
a first frame element extending from an upper end carrying a steering tube of a front wheel to a lower end,
a second frame element extending from an upper end receiving a seat unit to a lower end rigidly fixed to the first frame element,
a battery casing arranged in a battery housing space in rolling configuration, and
an electric motor driving one of the wheels,
the battery housing space being delimited at least in the vertical plane by a lower portion of the first frame element, a lower portion of the second frame element, and a footboard unit, said lower portions having bottom ends connected together and top ends between which the footboard unit extends in rolling configuration,
wherein the footboard unit has, at one end, a hinge pivotably connecting said footboard unit to one of the lower portions.

2. Two-wheeler according to claim 1, in which the lower portion of the first frame element has a concave-curved shape oriented substantially towards the seat unit.

3. Two-wheeler according to claim 1, in which the lower portion of the second frame element has a concave-curved shape oriented substantially forwards.

4. Two-wheeler according to claim 1, in which the footboard unit extends substantially horizontally with an upper surface situated at a height comprised between the height of the axis of the wheels and 45 cm.

5. Two-wheeler according to claim 1, in which the lower portion of the second frame element comprises a crankset housing, said housing being situated at a distance from the bottom end of said lower portion.

6. Two-wheeler according to claim 1, in which the footboard unit has, at an opposite end to the hinge, a locking device connecting said unit to the other lower portion in unlockable manner.

7. Two-wheeler according to claim 1, in which the footboard unit has an external electrical connection member, said connection member being arranged close to the hinge.

8. Two-wheeler according to claim 1, in which the battery casing is detachably attached to the footboard unit.

9. Two-wheeler according to claim 1, in which the hinge of the footboard unit, preferably connected to the second frame element, allows pivoting about a transversal horizontal axis allowing said footboard unit to pass from the rolling configuration to a substantially vertical configuration, called “removal configuration”.

10. Two-wheeler according to claim 9, in which the locking device is suitable for locking the footboard unit in the removal configuration.

11. Two-wheeler according to claim 10, in which the locking device comprises a mobile member mounted on the footboard unit and a first strike member mounted in a fixed manner on one of the frame elements, and a second strike member mounted in fixed manner on the other frame element, said mobile member being biased toward the locked position and the first and second strike members being configured to automatically ensure locking when the footboard unit reaches one of the rolling and removal configurations.

12. Two-wheeler according to claim 8, in which the battery casing and the footboard unit are attached in detachable manner by a set of tracks allowing disengagement in translational motion over a disengagement course substantially parallel to the footboard unit and in an opposite direction to the hinge thereof.
